(19) United States
(12) Patent Application Publication
(10) Pub. No.: US 2026/0152648 A1
(43) Pub. Date: Jun. 4, 2026

(54) POLYANILINE-POLYOXOMETALATE HYBRID COATINGS

(71) Applicants: Dong-Kyun Seo, Chandler, AZ (US); David Ciota, Scottsdale, AZ (US); Aiman Shabbir, Tempe, AZ (US)

(72) Inventors: Dong-Kyun Seo, Chandler, AZ (US); David Ciota, Scottsdale, AZ (US); Aiman Shabbir, Tempe, AZ (US)

(21) Appl. No.: 19/406,617

(22) Filed: Dec. 2, 2025

Related U.S. Application Data
(60) Provisional application No. 63/727,090, filed on Dec. 2, 2024.

(51) Int. Cl. C09D 5/24; C08J 7/044; C08K 3/22

(52) U.S. Cl. CPC C09D 5/24; C08J 7/044; C08K 3/22; C08J 2479/02; C08K 2003/2255; C08K 2201/011

(57) ABSTRACT

An electrically conductive coating includes polyaniline and metal oxide. Depositing an electrically conductive coating on a substrate includes dissolving a metal oxide in a solvent to yield a solution, combining aniline with the solution to yield a first mixture including polyoxometalate, combining an oxidizing agent with the first mixture to yield a second mixture, contacting a substrate with the second mixture to yield a coated substrate, removing the coated substrate from the second mixture, and drying the coated substrate.

### CROSS-REFERENCE TO RELATED APPLICATION

This application claims the benefit of U.S. Patent Application No. 63/727,090 filed on Dec. 2, 2024, which is incorporated by reference herein in its entirety.

### TECHNICAL FIELD

This invention relates to electrically conductive coatings synthesized from polyaniline and polyoxometalate clusters.

### BACKGROUND

Polyaniline (PANI) is a polymer that shows an intrinsic electrical conductivity. PANI films can be prepared through electrochemical or oxidative polymerization methods. Following oxidative polymerization, PANI precipitates can be used to coat nonconductive substrates through various methods.

### SUMMARY

This disclosure describes an oxidative polymerization of aniline in the presence of MoO₂(HPO₄)(H₂O) (PMo1), leading to in-situ interfacial synthesis of polyaniline (PANI) on nonconducting substrates. Based on the identification of a phosphomolybdate compound, [(C₆H₅NH₃)₅][Mo₅O₁₅(PO₄)(HPO₄)]·3H₂O, the interfacial synthesis is understood to occur due at least in part to strong interactions between anilinium and the phosphomolybdate, a Strandberg-type polyoxometalate. Using low concentrations of PMo1, aniline, and an oxidizing agent such as ammonium persulfate, PANI can be deposited on surfaces to produce smooth, homogenous thin films with thicknesses ranging from 1 nm-10 μm. Additionally, the polyoxometalate is incorporated within the films as determined via thermogravimetric analysis (TGA), Fourier transform infrared (FT-IR) spectroscopy and scanning electron microscopy (SEM) analyses. This method produces high quality, conductive PANI films through an in-situ chemical oxidation method without autocatalysis-induced PANI precipitation. The PMo1-PANI film synthesis can be used to coat high-curvature nanoparticles (e.g., silica), forming a core/shell particle structure, with molybdenum phosphate species present within the nanocomposite. These conductive nanocomposites can be used to coat nanoscale substrates (e.g., metal oxides and cellulose nanocrystals.)

In a first general aspect, an electrically conductive coating includes polyaniline and metal oxide.

Implementations of the first general aspect can include one or more of the following features.

In some cases, the metal oxide includes a polyoxometalate. The metal oxide can include a Strandberg-type metal oxide cluster. In some implementations, the Strandberg-type metal oxide cluster includes a [Mo₅O₁₅(PO₄)₂]⁶⁻ metal oxide cluster. The metal oxide can include a transition metal having a formal oxidation state of 4+, 5+, or 6+. In some implementations, the transition metal includes molybdenum, phosphorous, or both. In some cases, a thickness of the coating is in a range of 1 nm to 10 μm. The coating can be continuous with no visual voids greater than 10 nm. In some implementations, the polyaniline, the metal oxides, or both are in the form of nanoparticles. An average diameter of the nanoparticles can be 100 nm or less. In some cases, the nanoparticles are isotropic in shape. In some implementations, the coating is in the form of a film. In some cases, the coating is homogenous.

In a second general aspect, a coated substrate includes a substrate and the electrically conductive coating of the first general aspect on the substrate.

Implementations of the second general aspect can include one or more of the following features.

In some cases, the substrate includes paper, a polymer, or an inorganic compound. In some implementations, the inorganic compound includes silica. In some cases, the paper includes filter paper or wax paper. The polymer can include a perfluorinated polymer. In some implementations, the polymer includes polyethylene, polypropylene, poly(ethylene terephthalate), poly(methyl methacrylate), polyvinyl chloride, polyurethane, polycarbonate, polyester, polystyrene, silicone, rubber, cellulose, wool, aramid, polyphthalamide, polyimide or nylon. The electrically conductive coating can include two or more layers.

In a third general aspect, an aqueous composition includes aniline and metal oxide clusters.

Implementations of the third general aspect can include one or more of the following features.

In some implementations, the metal oxide clusters include Strandberg-type [Mo₅O₁₅(PO₄)₂]⁶⁻ metal oxide clusters.

In a fourth general aspect, a coating includes the composition of the third general aspect.

Implementations of the fourth general aspect can include one or more of the following features.

In some cases, the coating includes two or more layers.

In a fifth general aspect, depositing an electrically conductive coating on a substrate includes dissolving a metal oxide in a solvent to yield a solution, combining aniline with the solution to yield a first mixture including polyoxometalate, combining an oxidizing agent with the first mixture to yield a second mixture, contacting a substrate with the second mixture to yield a coated substrate, removing the coated substrate from the second mixture, and drying the coated substrate.

Implementations of the fifth general aspect can include one or more of the following features.

In some cases, dissolving the metal oxide in the solvent comprises combining the metal oxide to yield a mixture, and heating the mixture to yield the solution. In some implementations, the fifth general aspect further includes, before contacting the substrate with the second mixture, heating the second mixture to a temperature no greater than 100° C. The substrate can include an electrically insulating material. In some cases, the electrically insulating material includes an organic material, a polymer, or an inorganic material. A molar ratio of the aniline to a metal in the metal oxide can be in a range of about 1:1 to about 3:1. In some cases, the metal oxide includes MoO₂(HPO₄)(H₂O).

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a flow chart showing operations in a process to deposit an electrically conductive coating on a substrate. FIG. 1B shows a view of a single Mo₅O₁₅(HPO₄)(PO₄)₂⁵⁻Strandberg-type polyoxometalate cluster, Strandberg cluster with surrounding water and anilinium cations, and four Strandberg clusters with surrounding water and anilinium cations from the (100) direction. Hydrogen bonds are represented with dashed lines.

FIG. 2A shows Fourier transform infrared (FT-IR) spectra of MoO₂(HPO₄)(H₂O) (PMo1) and [(C₆H₅NH₃)₅][Mo₅O₁₅(PO₄)(HPO₄)]·3H₂O. FIG. 2B shows thermogravimetric analysis (TGA) thermograms of PMo1 and [(C₆H₅NH₃)₅][Mo₅O₁₅(PO₄)(HPO₄)]·3H₂O.

FIG. 3A shows film thickness of PMo1-polyaniline (PANI) films that were grown for 8, 10, 12, and 24 hours. A line of best fit obtained from linear regression is shown and demonstrates the continuous deposition of PMo1-PANI films. FIG. 3B shows sheet resistance of PMo1-PANI films that were grown for 8, 10, 12, and 24 hours.

FIG. 4A shows FT-IR spectra of PMo1-PANI film grown for 24 hours and bulk PANI. FIG. 4B shows TGA thermograms of PMo1-PANI film grown for 24 hours and bulk PANI.

FIGS. 5A and 5B show schematic illustrations of potential structures via polymerization of aniline in the presence of silica nanoparticles.

FIGS. 6A and 6B shows transmission electron microscopy (TEM) micrographs of MoPL10 after 4 hours of polymerization. MoPL10 is a sample prepared with nominal PMo1:aniline:SiO₂ ratios of 1:1:10. The inset shows a particle size histogram for 100 particles.

FIG. 7A shows thermograms of MoPL and PL samples. Samples prepared with PMo1 are referred to as MoPL samples and the control samples prepared without PMo1 are referred to as PL samples. MoPL5, MoPL10, MoPL20 correspond to samples prepared with nominal PMo1:aniline:SiO₂ ratios of 1:1:5, 1:1:10 and 1:1:20, respectively. PL5, PL10, and PL20 correspond to samples prepared with nominal aniline:SiO₂ ratios of 1:5, 1:10, and 1:20, respectively. FIG. 7B shows simulated differential scanning calorimetry (DSC) of MoPL and PL samples. FIG. 7C shows FT-IR spectra of MoPL and PL samples.

FIG. 8A shows Brunauer-Emmett-Teller (BET) gas-sorption isotherms of MoPL and PL samples. FIG. 8B shows Barrett-Joyner-Halenda (BJH) desorption of MoPL and PL samples.

FIGS. 9A, 9B, and 9C show X-ray photoelectron spectroscopy (XPS) spectra of MoPL10 and PL10.

FIG. 10 shows Mo 3d high resolution XPS spectra of MoPL10.

FIG. 11 shows the powder X-ray Diffraction (PXRD) patterns of cellulose nanocrystals (CNC), PMo1, and the CNC-PMo1-PANI nanocomposite (MoPC4). MoPC4 corresponds to samples prepared with nominal PMo1:aniline:CNC ratios of 1:1:4.

FIG. 12 shows the FT-IR spectrum for CNC and the MoPC4 samples.

### DETAILED DESCRIPTION

This disclosure describes in-situ interfacial synthesis of polyaniline (PANI) performed via oxidative polymerization. The interfacial synthesis occurs in the presence of phosphomolybdate Strandberg-type polyoxometalates in solution. A Strandberg-type polyoxometalate (used interchangeably herein with “Strandberg polyoxometalate”) refers to a class of polyoxometalates having a chemical formula [X₂M₅O₂₃]^{z-} whose structure includes five MO₆ octahedra forming a pentagonal unit and two XO₄ tetrahedra capping the two opposite faces of the pentagon. Possible M ions include Mo⁶⁺, W⁶⁺ and V⁵⁺, where X can be P⁵⁺, As⁵⁺ and Si⁴⁺, among others. One well-known example is [P₂Mo₅O₂₃]⁶⁻. As used herein, “interfacial synthesis” refers to synthesis of PANI that occurs exclusively or primarily at the interface of or in an interfacial region of a solid (e.g., an electrically insulating substrate) and a liquid (e.g., an aqueous solution including polyoxometalate, aniline, and an oxidizing agent).

The presence of the Strandberg-type polyoxometalate was confirmed via the identification of a crystal structure with a molecular formula of [(C₆H₅NH₃)₅][Mo₅O₁₅(PO₄)(HPO₄)]·3H₂O, in which [Mo₅O₁₅(PO₄)(HPO₄)]⁵⁻ is packed together with anilinium cations (C₆H₅NH₃). The compound can be produced when an excess amount of aniline is added to an aqueous solution of MoO₂(HPO₄)(H₂O) (PMo1).

Phosphomolybdate Strandberg-type polyoxometalate materials can induce the polymerization of aniline at interfaces (e.g., solid-liquid), when it is obtained through the dissolution of PMo1. The crystal structure of PMo1 has a one-dimensional crystal structure composed of MoO₅(H₂O) octahedra and HPO₄ tetrahedra which share their corners in one dimension to form double chains. The individual chains are held together via hydrogen bonds between aqua ligands and the oxo ligands of adjacent chains. When PMo1 is dissolved in water, the chains are likely to be hydrolyzed into smaller species. The combination of PMo1 with aniline (e.g., PMo1:aniline=1:2 in moles) leads to the formation of large needle-like crystals. The crystals have a chemical formula of [(C₆H₅NH₃)₅][Mo₅O₁₅(PO₄)(HPO₄)]·3H₂O, whose structure contains a Strandberg-type polyoxometalate that is surrounded by anilinium countercations. However, such crystal formation can be reduced or avoided under a lower concentration condition and preferably with a lesser amount of aniline (e.g., PMo1:aniline=1:1 in moles), and upon addition of an oxidizing agent, oxidative polymerization of aniline results in growth of PANI films at interfaces with negligible formation of granules in solution. This interfacial polymerization produces high quality conductive films and demonstrates an in-situ coating method with negligible formation of the PANI precipitate.

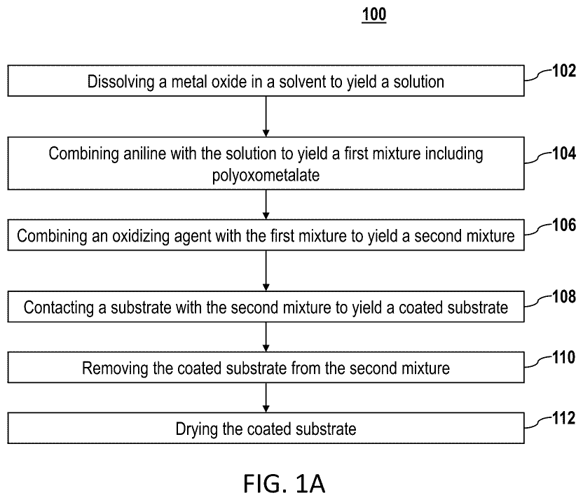

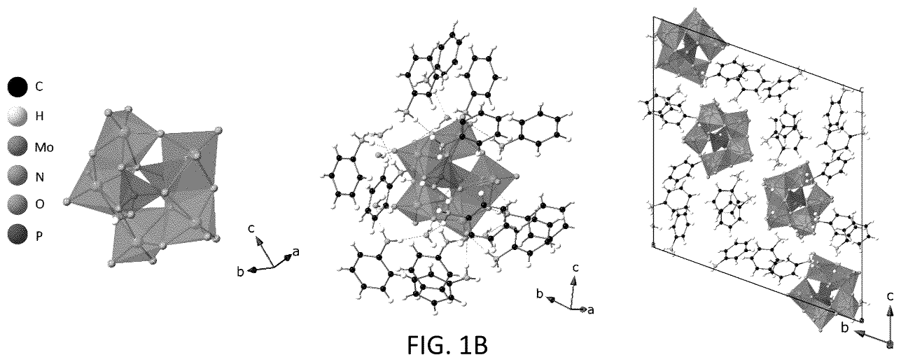

FIG. 1A shows operations in process 100 to deposit an electrically conductive coating on a substrate. In 102, a metal oxide is dissolved in a solvent to yield a solution. A suitable example of the metal oxide includes MoO₂(HPO₄)(H₂O). In 104, aniline is combined with the solution to yield a first mixture including polyoxometalate. In some cases, dissolving the metal oxide in the solvent includes combining the metal oxide to yield a mixture, and heating the mixture to yield the solution. A molar ratio of the aniline to a metal in the metal oxide is typically in a range of about 1:1 to about 3:1. In 106, an oxidizing agent is combined with the first mixture to yield a second mixture. In 108, a substrate is contacted with the second mixture to yield a coated substrate. The substrate typically includes an electrically insulating material (e.g., an organic material, a polymer, an inorganic compound). In 110, the coated substrate is removed from the second mixture. In 112, the coated substrate is dried. Before contacting the substrate with the second mixture, the second mixture can be heated to a temperature greater than 100° C.

The PMo1-PANI coating method can be used to prepare PANI nanocomposites containing nanostructures of oxides. The nanostructures include gels, nanofibers and nanoparticles. The oxides can be metal oxides that are insoluble at a pH not greater than 6. Such metal oxides include silica (SiO₂), titania (TiO₂), MoO₃, WO₃, V₂O₅ and Ta₂O₅. In some cases, the nanostructures of the oxides is colloidal silica with diameters in a range of 5 nm to 100 nm (e.g., 20 nm). Nanocomposites prepared with these types of nanoparticles typically have raspberry-like morphologies, in which silica nanoparticles cover PANI granules. The addition of PMo1 to silica/PANI nanocomposite synthesis results in aggregated silica/PANI core/shell particles that have an additional outer coating of PANI. The PMo1-PANI coating method can be applied to the substrates other than silica, including organic polymers and metal oxides. The substrate can include an organic material, polymer, or an inorganic compound. The physical forms of the substrate materials can include particles, wires, rods, fibers, plates, or films. The physical forms of the substrate materials can have curved surfaces.

This disclosure also describes using a PMo1-PANI coating method to prepare PANI nanocomposites including cellulose nanocrystals (CNC). The CNC used for the samples were approximately 5 nm-10 nm in width and 75 nm-250 nm in length. The nanocomposites showed fibrous structures where nano-whiskers intertwine to form a matrix including polyaniline.

### Examples

To synthesize MoO₂(HPO₄)(H₂O) (PMo1), 4.95 g of MoO₃ (Alfa Aesar, 99.95%) was placed in a 250 mL round bottom flask with 15 mL of 85 wt % H₃PO₄ (Alfa Aesar). The resulting mixture was refluxed at 160° C. until MoO₃ was dissolved, and a transparent pale green solution was present. Then, the solution was cooled and 90 mL of concentrated HNO₃ (BDH, 69-70%) was added. The solution was refluxed at 160° C. for 12 hours. After refluxing for 12 hours, a white precipitate was present and the solution was cooled to room temperature. The white precipitate was collected via vacuum filtration, washed with 200 mL of acetone (BDH, 98.5%), air dried overnight and stored in polypropylene centrifuge tubes for further use. The product was confirmed to be PMo1 via powder X-ray diffraction (PXRD) analysis.

To synthesize [(C₆H₅NH₃)₅][Mo₅O₁₅(PO₄)(HPO₄)]·3H₂O, 0.300 g (1.24 mmole) of PMo1 was combined with 15 mL of deionized water in a polypropylene centrifuge tube and was heated in a 60° C. oven. The resulting transparent solution was slightly yellow when warm. The solution was cooled to room temperature, at which the solution was colorless. Separately, 0.214 mL (2.48 mmole) of aniline (Sigma Aldrich, 99.5%) was dissolved in 10 mL of deionized water. After the aniline solution was added to PMo1 solution, large needle-like crystals started to form within five minutes. The solution was kept undisturbed for two hours and the crystals were collected via vacuum filtration, washed with 150 mL of hexane (BDH, 98.5%) and air dried. The samples were stored in borosilicate glass vials for further use and characterization.

To synthesize polyaniline (PANI) films, VWR Vista Vision™ microscopes slides (soda-lime glass) were used as substrates and the polymerization was carried out in 250 mL Pyrex beakers. Before their use, the microscope slides were sonicated in ethanol (Koptec, 99.5%) in an ultrasonicator (VWR Aquasonic Model 75HT, 360 W) for 10 minutes and dried thoroughly with nitrogen gas. A PMo1 solution (0.300 g of PMo1 in 100 mL of deionized water) was prepared first and mixed with 0.107 mL (1.24 mmole) of aniline. The solution was stirred for 5 minutes, and 2 mL of 50 mg/mL (0.5 mmole) ammonium persulfate solution was added and stirred for 5 more minutes. The precleaned glass slides were placed in the solution, leaning against the beaker wall, and left undisturbed until they were removed after 8, 10, 12 or 24 hours. Once removed, the slides were rinsed with deionized water, then soaked in 1 M HCl for 30 minutes. Following this, the slides were rinsed again with deionized water, dried with nitrogen gas and dried further in a lab oven at 60° C. for 30 minutes. These films are referred to as PMo1-PANI films.

To compare the disclosed polymerization process with a reference process, PANI films were prepared oxidatively without PMo1. 0.107 mL (1.24 mmol) of aniline was added to 100 mL of 1M HCl. The solution was stirred for 5 minutes during which aniline dissolved. Then, 2 mL of 50 mg/mL (0.5 mmole) ammonium persulfate solution was added and stirred for 5 minutes. The precleaned glass slides were placed in the solution and left undisturbed until they were removed after 8, 10, 12 or 24 hours. Once removed, the films were washed and dried.

The polymerization process was further compared with the polymerization reaction in which Na₂MoO₄·2H₂O and H₃PO₄ were used to mimic PMo1. 0.300 g (1.24 mmol) of Na₂MoO₄·2H₂O (Sigma Aldrich, 99.5%) and 80 μL (1.2 mmol) of 85 wt % H₃PO₄ (Alfa Aesar) were dissolved in 100 mL of deionized water while being stirred on a hot plate at 60° C. The resulting solution was optically transparent and faint yellow in color. The solution was cooled to room temperature, at which the solution was colorless. Then, 0.107 mL (1.2 mmol) of aniline (Sigma Aldrich, 99.5%) was added to the solution. The combined solution was stirred for 5 minutes, and 2 mL of 50 mg/mL (0.5 mmole) ammonium persulfate solution was added and stirred for 5 minutes. Subsequently, PANI films were produced on the precleaned glass slides.

Single crystal X-ray crystallography was performed with a Rigaku XtaLAB Synergy diffractometer coupled to a dual microfocus X-ray source (Mo/Cu), a HyPix-6000HE Hybrid Photon Counting (HPC) detector and an Oxford Cryosystems 800 Series Cryostream. A crystal with dimensions of 0.404×0.058×0.028 mm³ was used for analysis. Thermogravimetric analysis (TGA) assessments of PMo1, [(C₆H₅NH₃)₅][Mo₅O₁₅(PO₄)(HPO₄)]·3H₂O, PMo1-PANI films and PANI samples were performed using a Mettler Toledo TGA/Differential scanning calorimetry (DSC) 1 instrument equipped with GC 200 gas controller. The samples were analyzed by heating from 30° C. to 600° C. at a heating rate of 10° C. min⁻¹ in O₂ gas flowing at 50 mL min⁻¹. The Fourier transform infrared (FT-IR) spectra of PMo1, [(C₆H₅NH₃)₅][Mo₅O₁₅(PO₄)(HPO₄)]·3H₂O, PMo1-PANI film and PANI were recorded using a Bruker IFS66 V/S attenuated total reflection (ATR) FT-IR spectrometer. FT-IR and TGA analysis of the PMo1-PANI film were performed on film grown for 24-hours that was scraped off the substrate with a stainless-steel spatula.

Scanning electron microscopy (SEM) and energy dispersive spectroscopy (EDS) spectroscopy of the PMo1-PANI films was performed with an Auriga SEM/focused ion beam (FIB) Zeiss operated at 15 kV. Surface imaging and thickness determination of PMo1-PANI films was performed using a Zygo ZeScope optical profilometer. To obtain the thickness of each film, four scratches were added to the films with a stainless-steel spatula. Sheet resistance measurements for all PMo1-PANI films were obtained using KLA Tencor Omni mapper 4-point probe. Sheet resistance was measured at three positions on the film and then averaged for each film.

In a mixture solution of PMo1 and aniline, crystallization occurs when the aniline to PMo1 ratio is at least 2 and the concentration of PMo1 is at least 25 mM. The crystals, which formed almost immediately after the solution was prepared, were found to be soluble in polar solvents including water, methanol, ethanol, and acetone. The molecular formula of the crystals was determined to be [(C₆H₅NH₃)₅][Mo₅O₁₅(PO₄)(HPO₄)]·3H₂O via single crystal X-ray diffraction analysis. The unit cell parameters are a=8.28540(5) Å, b=24.2892(2) Å, c=25.1872(2) Å, α=69.1217(6)°, β=80.8973(5°) and γ=80.6106(5°) in the P1̅ space group. Further crystallographic information can be found in Table 1. The crystal structure features columns of Strandberg-type polyoxometalate clusters ([Mo₅O₁₅(PO₄)(HPO₄)]⁵⁻), which are surrounded by anilinium (C₆H₅NH₃⁺) cations and water molecules. FIG. 1B shows an isolated Strandberg cluster, a Strandberg cluster with surrounding anilinium cations as well as the packing of Strandberg-type clusters and anilinium.

TABLE 1
Crystallographic data table for
[(C₆H₅NH₃)₅][Mo₅O₁₅(PO₄)(HPO₄)] · 3H₂O.

| Formula | [(C₆H₅NH₃)₅][Mo₅O₁₅(PO₄)(HPO₄)] · 3H₂O | |
|---|---|---|
| Empirical Formula | C₃₀H₄₇Mo₅N₅O₂₆P₂ | |
| Formula Weight | 1435.36 | |
| Temperature (K) | 100(1) | |
| Wavelength (Å) | 1.54184 | |
| Crystal System | Triclinic | |
| Space Group | P-1 | |
| Unit Cell Dimensions | a = 8.28540(5) Å | α = 69.1217(6)° |
| | b = 24.28924(15) Å | β = 80.8973(5)° |
| | c = 25.18721(16) Å | γ = 80.6106(5)° |

| | |
|---|---|
| Volume (Å³) | 4644.95(5) |
| Z | 4 |
| Crystal Size | 0.404 × 0.058 × 0.028 mm3 |

The Strandberg-type cluster (Mo₅O₁₅(PO₄)(HPO₄)⁵⁻), as shown in FIG. 1B, is composed of five distorted MoO₆ octahedra and two phosphate tetrahedra. Three of the MoO₆ octahedra share two edges while the other two octahedra share one edge and one corner. Together, the five octahedra form a ring with the two capping phosphate tetrahedron. These Strandberg-type polyoxometalates in the crystals hydrogen bond with surrounding structural water molecules and anilinium cations, as shown in FIG. 1B. Lengthened C—N bonds in the anilinium also support the observed protonation and hydrogen bonding. The C—N bond distance of non-hydrogen bonded and non-protonated aniline is expected to be 1.37-1.42 Å.

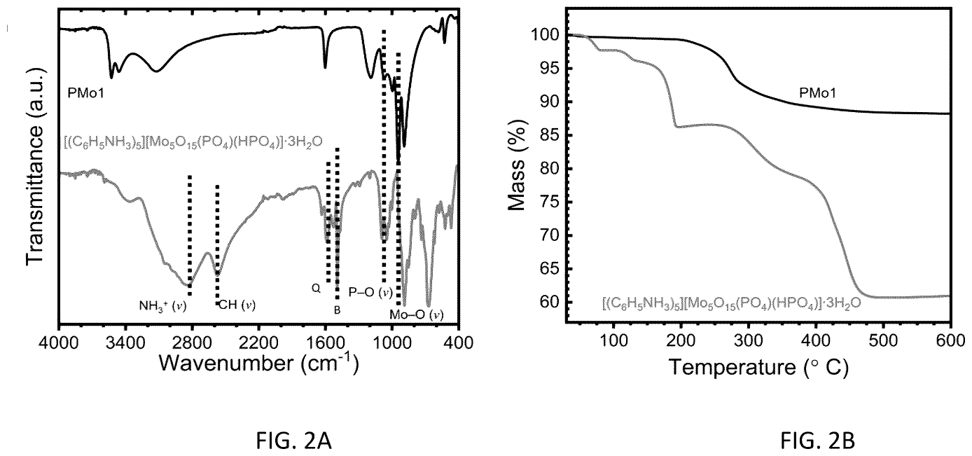

FT-IR and TGA were performed to characterize [(C₆H₅NH₃)₅][Mo₅O₁₅(PO₄)(HPO₄)]·3H₂O, as shown in FIGS. 2A and 2B. The FT-IR spectra of PMo1 and [(C₆H₅NH₃)₅][Mo₅O₁₅(PO₄)(HPO₄)]·3H₂O crystals are shown in FIG. 2A. Peak assignments can be found in Table 2. The peaks at 3126 and 1600 cm⁻¹ are assigned to the O—H stretch and H—O—H bending vibrations of aqua ligands, respectively. Phosphate vibrations of PMo1 are located at 1194, 1050, 1008, and 874 cm⁻¹ and are assigned to the O—P—O stretch, P—O asymmetric stretch, P—O symmetric stretch and P—O—H stretch, respectively. The molybdenum-oxo vibrations are located at 936 and 574 cm⁻¹ and are assigned to Mo—O and O—Mo—O, respectively.

TABLE 2
FT-IR peak positions (cm⁻¹) and assignments of PMo1
and [(C₆H₅NH₃)₅][Mo₅O₁₅(PO₄)(HPO₄)] ·
3H₂O. The symbols ν, and δ represent stretching
and bending vibrational modes, respectively.

| Assignment | PMo1 | [(C₆H₅NH₃)₅][Mo₅O₁₅(PO₄)(HPO₄)] · 3H₂O |
|---|---|---|
| H₂O (ν) | 3118 | 3051 |
| NH₃⁺ (ν) | — | 2840 |
| C—H (ν) | — | 2568 |
| NH₃⁺ (δ) | — | 1635 |
| H₂O (δ) | 1600 | 1606 |
| Quinoid (Q, ring | — | 1591 |
| breathing) | | |
| Benzoid (B, ring | — | 1492 |
| breathing) | | |
| C—N (ν) | — | 1330, 1292 |
| O—P—O | 1189 | 1199 |
| P—O (asym, ν) | 1074 | 1091 |
| P—O (sym, ν) | 991 | 1002 |
| Mo—O (ν) | 943 | 943 |
| P—OH (ν) | 891 | 889 |

The FT-IR spectrum of [(C₆H₅NH₃)₅][Mo₅O₁₅(PO₄)(HPO₄)]·3H₂O in FIG. 2A shows the presence of N—H stretches at 2837 and 2578 cm⁻¹, suggesting the presence of anilinium. The NH₃⁺ and H₂O bending peaks can be seen at 1635 and 1606 cm⁻¹, respectively, further confirming the presence of anilinium species and water molecules. A strong peak at 1492 cm⁻¹ is assigned to benzoid ring stretching of anilinium, and a smaller peak at 1591 cm⁻¹ can be assigned to quinoid ring stretching. The latter suggests a that small degree of polymerization may have occurred. The peaks observed at 1100-1000 cm⁻¹ and at 943 cm⁻¹ are assigned to the P—O stretch and Mo—O stretch, respectively, of the phosphomolybdate Strandberg cluster. Some of the phosphomolybdate stretches overlap with strong anilinium vibrations. For example, the P—O—H peak should be present at 890 cm⁻¹ but this region is dominated by the ring C—H stretch and ring deformation vibrations of anilinium cations. The FT-IR spectrum supports the presence of protonated aniline (anilinium), water, and phosphomolybdate species.

Thermogravimetric analysis in FIG. 2B also supports the molecular formula obtained from single crystal X-ray diffraction analysis. For PMo1, the mass is continuously lost in the region of 200-600° C., with an overall mass loss of 11%. The weight loss accelerates up to about 270° C. and then suddenly decelerates. The initial weight loss (approximately 7%) could be due at least in part to the loss of the aqua ligand (7.5% of the molecular formula). In a thermogram of [(C₆H₅NH₃)₅][Mo₅O₁₅(PO₄)(HPO₄)]·3H₂O, a small amount of mass (2%) is initially lost before 85° C. and is attributed at least in part to adsorbed water. Following this, negligible mass is lost until 110° C. Then, 2.5% of the mass is slowly lost between 11° and 165° C. This mass loss is assigned to two crystal water molecules with each accounting for 1.25% of the mass based on the molecular formula. Following the loss of water, a 9% mass loss is observed between 165 and 200° C. This mass loss is assigned to the loss of one anilinium ion (6.56% of the mass based on the molecular formula) and one water molecule. Between 200° C. and 280° C., negligible mass is lost until 270° C. Between 270° C. and 500° C., there are two distinct regions where mass losses occur. First, approximately 11% mass loss occurs from 270° C. to 410° C. and then approximately 15% is lost between 410° C. and 500° C. Combined, they account for approximately 26% loss in the sample mass which is assigned to the loss of the remaining four anilinium ions. The mass loss again correlates well with the DSC data, which shows two broad exothermic peaks that are assigned to the combustion of anilinium ions. Overall, the mass loss assignable to [(C₆H₅NH₃)₅][Mo₅O₁₅(PO₄)(HPO₄)]·3H₂O crystals is 37.5%, which closely matches the theoretical mass loss of 38.2% based on the molecular formula.

Crystals of [(C₆H₅NH₃)₅][Mo₅O₁₅(PO₄)(HPO₄)]·3H₂O were observed to form when excess aniline was added to the PMo1 solution while the PMo1 concentration remained the same. In cases where the PMo1 and aniline mole ratios were equivalent, crystallization did not occur. Thus, oxidative polymerization of aniline was performed. Polymerization occurred almost exclusively at interfaces (for example, liquid-glass and liquid-air). This contrasts with control assessments performed without PMo1 and with solutions containing Na₂MoO₄·2H₂O and H₃PO₄. When PMo1 is used, there is a thicker coating on the beaker walls and little of PANI precipitate in the supernatant. In contrast, the control assessments produced a considerable amount of precipitate suspended in solution and visually thinner films on the beaker walls. Since PANI was observed to form directly on interfaces, various substrates were coated in-situ to prepare PANI thin films with varying thickness. Substrates which were successfully coated include filter paper, weigh/wax paper, Teflon, nylon, cotton, and fumed silica. Metallic surfaces such as aluminum foil, copper shot and zinc shot could not be effectively coated. To assess the deposition behavior on non-metallic surfaces, thin films were prepared by submerging glass microscope slides in the polymerization solution and removing them after 8, 10, 12 and 24 hours. After 8 hours, a near-homogeneous transparent green film is present but becomes less transparent after 10, 12 and 24 hours of polymerization time.

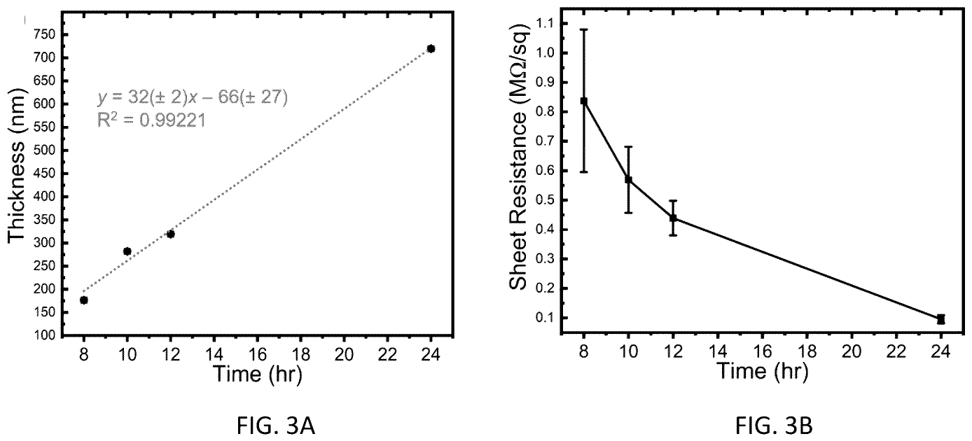

To assess the film growth, profilometry analysis was performed on the prepared films. The film thicknesses were determined by adding thin cuts to the films with a stainless-steel spatula. The average film thickness and RMS values of the coatings is shown in Table 3. From profilometry studies, the thicknesses of the films were 176 (±7), 281 (±5), 319.00 (±5) and 719.43 (±9) nm after allowing growth for 8, 10, 12, and 24 hours, respectively. The respective RMS values were 7.28 (±2), 6.34 (±1), 9.12 (±1) and 9.7 (±1) nm. Based on the change in film thickness over time as shown in FIG. 3A, the film growth is nearly linear. The linear regression line suggests that approximately 32 nm of PMo1-PANI film is added per hour of polymerization. This growth is slow, but the deposition is continuous over a considerable time and the small RMS values show surface homogeneity of the films.

TABLE 3
Optical profilometry film thickness and RMS values of
PMo1-PANI films grown for 8, 10, 12 and 24 hours.

| Film Growth Time (hr) | Thickness (nm) | RMS (Sq, nm) |
|---|---|---|
| 8 | 176 (±7) | 7 (±2) |
| 10 | 281 (±5) | 6 (±1) |
| 12 | 319 (±5) | 9 (±1) |
| 24 | 719 (±9) | 9 (±1) |

Additionally, sheet resistances of the pristine films were measured using a 4-point probe. The sheet resistance of pristine coatings as a function of polymerization time is shown in FIG. 3B. As the polymerization time increases, the sheet resistance decreases from 8.37×10⁵ to 9.51×10⁴ Ω/sq as the film is allowed to grow from 8 to 24 hours. Sheet resistances for all measured films can be found in Table 4. Furthermore, with knowledge of the individual film thickness, the calculated bulk resistivities are shown in Table 4. The sheet resistance and bulk resistivity decreases as the polymerization time and film thickness increases. The bulk resistivity of the PMo1-PANI films is higher than reference resistivities of pure emeraldine salt PANI (approximately 0.1 Ω/cm) which is expected due at least in part toto the potential incorporation of phosphomolybdate species.

TABLE 4
Sheet resistance collected via 4-point probe measurements
and calculated bulk resistivity of PMo1-PANI films
grown for 8, 10, 12 and 24 hours.

| Film Growth | Sheet | Bulk |
|---|---|---|
| Time (hr) | Resistance (Ω/sq) | Resistivity (Ω · cm) |
| 8 | 8.37 × 10⁵ | 14.8 |
| 10 | 5.69 × 10⁵ | 16.0 |
| 12 | 4.39 × 10⁵ | 14.0 |
| 24 | 9.51 × 10⁴ | 6.8 |

To further assess the film surfaces, SEM imaging was performed. Low magnification images of the films obtained after 8, 10, 12 and 24 hours of polymerization reveal a smooth coating overall. However, surface aggregates with diameters of 500 nm-5000 nm are also present. Larger aggregates appear in higher amounts in the 10-hour and 12-hour films compared to the 8-hour and 24-hour films. The 24-hour film has discreet isolated particles which are 1000 nm-2000 nm in diameter. Aggregates appear to be embedded in the film of all measured samples, suggesting that the PMo1-PANI film grows from various nucleation sites. In addition to imaging, EDS analysis was performed to confirm the presence of molybdenum phosphate species. In all films, both Mo and P were detected with a Mo:P atomic ratio of 7:1 and EDS mapping suggests that Mo, P, and C are all homogenously distributed. While the molybdenum to phosphorous ratio of 7:1 is higher than the 5:2 ratio of a Strandberg-type polyoxometalate, the expected presence of sulfur, introduced via ammonium persulfate, likely leads to an observed increase in the Mo:P ratio. This is due at least in part to the similar energies of the Mo La (2.293 eV) and S Kα (2.307 eV) characteristic X-rays. Overall, SEM analysis reveals the presence of a relatively smooth coating and supplements the profilometry analysis.

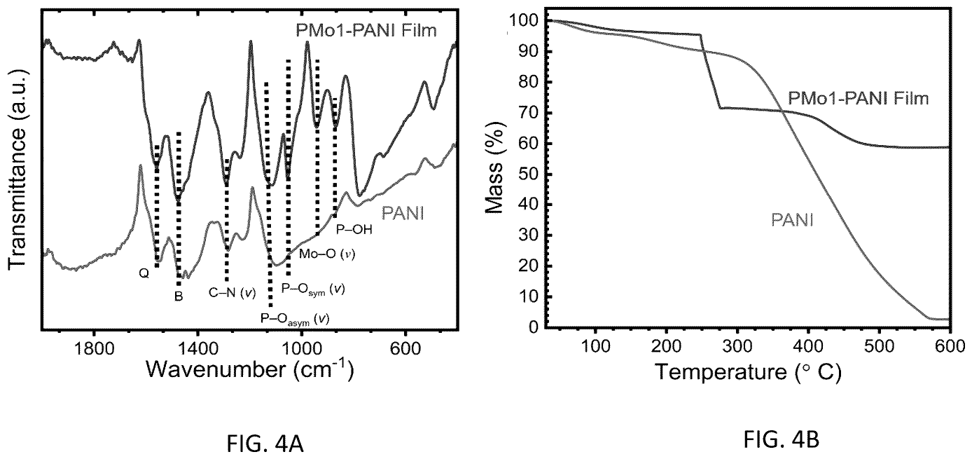

For further characterization, a film that was grown for 24 hours was removed from the glass substrate to perform FT-IR and TGA analysis. The FT-IR spectra and TGA thermograms of the 24-hour PMo1-PANI film, as well as PANI precipitate (synthesized with no PMo1) as a reference, are shown in FIGS. 4A and 4B. FT-IR analysis is focused on peaks from 1800 cm⁻¹-400 cm⁻¹ which can be used to identify both PANI and molybdenum phosphate species. Peak positions and assignment for PMo1-PANI films and PANI are shown in Table 5. The peak at 1552 cm⁻¹ as well as the peaks between 1473 cm⁻¹-1438 cm⁻¹ can be assigned to the ring breathing of quinoid (Q) and benzoid (B) rings in PANI, respectively. Peaks at 1282 cm 1 and 1224 cm⁻¹ can be assigned to C—N stretch of PANI. Finally, a broad peak at 1100 cm⁻¹ can be assigned to a combination of benzene-NH-benzene stretching or, potentially, C—H deformation while a small peak at 786 cm⁻¹ is assignable to C—H mono- or disubstituted deformation vibrations.

TABLE 5
FT-IR peak positions (cm⁻¹) and assignments of PMo1
and [(C₆H₅NH₃)₅][Mo₅O₁₅(PO₄)(HPO₄)] ·
3H₂O. The symbols ν, and δ represent stretching
and bending vibrational modes, respectively.

| Assignment | PANI | PMo1-PANI Film |
|---|---|---|
| Quinoid (Q, ring breathing) | 1552 | 1560 |
| Benzoid (B, ring breathing) | 1473, 1438 | 1475 |
| C—N (ν) | 1282, 1224 | 1296,1238 |
| B—NH—B (ν) or C—H deformation | | |
| P—O (asym, ν) | — | 1107 |
| P—O (sym, ν) | — | 1053 |
| Mo—O (ν) | — | 941 |
| P—OH (ν) | — | 870 |

For the FT-IR spectra of PMo1-PANI film, peaks at 1560 cm⁻¹, 1475 cm⁻¹, 1296 cm⁻¹ and 1238 cm⁻¹ are assigned to the quinoid, benzoid and C—N vibrations, respectively, and confirms the presence of PANI. Additionally, anilinium ions can be identified by a small peak at 1656 cm⁻¹ which is assigned the NH₃⁺ bending vibration. Peaks at 941 cm⁻¹ and 870 cm⁻¹ can be assigned to Mo—O and P—OH stretches, respectively, suggesting that a molybdenum phosphate species is present. Additionally, two peaks at 1107 cm⁻¹ and 1053 cm⁻¹ are different from the PANI spectrum and can be assigned to the symmetric P—O and asymmetric P—O stretches. FT-IR analysis confirms successful preparation of PANI and suggests Strandberg-type polyoxometalates were incorporated into the films.

The thermograms of PANI precipitate shows a slow mass loss of 4.5% to 130° C. followed by an additional 7.9% loss of its mass from 130° C. to 300° C., as shown in FIG. 4B. After 300° C., PANI rapidly loses mass until 575° C. at which point only 2.5% of the original PANI mass remains. The thermogram of the PMo1-PANI film is different, as shown in FIG. 4B. Initially, a 4.9% mass loss occurs when heated from 30° C. to 250° C. Following this, 23.5% of the mass is rapidly lost between 250° C. and 275° C., after which there is negligible mass loss until 400° C. Between 400° C. and 500° C., a mass loss of roughly 10% occurs. The initial mass loss, below 250° C., is assigned to absorbed water or aniline hydrochloride species. The mass losses, at 250° C. and between 400° C. and 500° C., are assigned to the loss and carbonization of PANI. Overall, the mass loss assignable to the PMo1-PANI film is 36.4%, which is close to the 37.5% mass loss observed for [(C₆H₅NH₃)₅][Mo₅O₁₅(PO₄)(HPO₄)]·3H₂O crystals. Together, the EDS, FT-IR and TGA analysis suggests that the PMo1-PANI films include PANI that are homogenously impregnated with Mo₅O₁₅(PO₄)(HPO₄).

Fourier transform infrared (FT-IR) spectra were recorded using a Bruker IFS66 V/S ATR FT-IR spectrometer. Thermogravimetric analysis (TGA) measurements were conducted using a Mettler Toledo TGA/DSC 1 instrument equipped with GC 200 gas controller. All samples were analyzed by heating from 30° C. to 600° C. at a heating rate of 10° C. min⁻¹ in O₂ gas flowing at 50 mL min⁻¹. Dynamic light scattering (DLS) and zeta potential measurements of MoPL and PL solutions were performed on a Malvern Nano-ZetaSizer instrument at 25° C. with 173° backscatter measurement angle using polystyrene disposable cuvettes. Small aliquots of sample were removed 2, 4, 6, 8, and 24 hours after the ammonium persulfate solution was added for time-dependent DLS and Zeta-potential studies.

SEM was performed using a Zeiss Auriga FIB/SEM operated at 15 kV. SEM samples were prepared by mounting them on an aluminum SEM stub with carbon tape and were carbon-coated before analysis. Transmission electron microscopy (TEM) was performed on MoPL10 solution after 4 hours of polymerization time using a Titan 80-300 FEI-TEM operated at 300 kV. The sample was prepared by drop-casting the polymerization solution directly onto copper TEM grids with thin holey carbon. Surface area analysis was performed using a Micrometrics ASAP 2020 surface area and porosity analyzer. Specific surface area was calculated based on the Brunauer-Emmett-Teller (BET) method, the pore volume was determined with the t-plot method and the pore distribution using the Barrett-Joyner-Halenda (BJH) method.

X-ray photoelectron spectroscopy (XPS) was performed on a Kratos Axis Ultra 165 Hybrid Ultrahigh Vacuum Photoelectron Spectrometer. Survey spectra were measured at a pass energy of 160 eV and high-resolution spectra with a pass energy of 20 eV. Analysis was performed on CasaXPS software (version 2.3.24). For the C 1s, N 1s, P 2p, Si 2p and Mo 3d high resolution spectra, calibration was performed by adjusting the adventitious carbon peak to a binding energy of 284.8 eV and applying the resulting shift to each spectrum. Backgrounds for all components were determined with the Shirley function present in the CasaXPS software.

To compare the potential differences in polymerization of aniline with colloidal silica, the reactions were monitored via visual observation, DLS, and Zeta-potential analysis. Visual observation of the MoPL contrasts to the PL control assessments. MoPL solutions initially form transparent green solutions after 4 hours, but transition to a dark green solution after 8 hours. pH of all solutions is similar (pH˜4 via litmus paper tests) At this point, aggregation and sedimentation in MoPL solutions is observed if stirring is stopped. In contrast, PL solutions form a transparent brown solution after 4 hours and a cloudy deep brown solution after 8 hours. After 24 hours, all solutions were dark green, which is expected of PANI in the conductive emeraldine salt state. The difference in color at early stages of polymerization suggests that aniline is preferentially polymerizing in the conductive emeraldine state PMo1 is present. Without PMo1, the observed brown color is likely caused by the presence of leucoemeraldine, which is the non-conductive form of PANI. The leucoemeraldine-like brown color changes to an emeraldine-like green color over 24 hours, but the difference between samples prepared with or without PMo1 suggests that the initial polymerization products are different from one another.

The synthesis was repeated using a 0.40 M PMo1 solution instead of 0.08 M. The polymerization reaction exhibited an accelerated rate under these conditions. Uniform greenish-blue PANI coatings were obtained on both soda-lime glass substrates and poly(ethylene terephthalate) (PET) films within approximately 2 hours of initiation. After this time, negligible further film growth or deposition was observed, indicating that the reaction had reached completion.

To synthesize PMo1-PANI-silica nanocomposites, 0.300 g (1.24 mmole) of PMo1 was dissolved in 100 mL deionized water on a 60° C. hotplate. When PMo1 was fully dissolved the solution was cooled and 0.107 mL (1.24 mmole) of aniline (Sigma Aldrich) was added. To this, a colloidal silica solution (LUDOX TM-50, Sigma Aldrich) was added. To prepare solutions with nominal PMo1:aniline:SiO₂ mole ratios of 1:1:5, 1:1:10 and 1:1:20, respectively, 0.51, 1.01 and 2.02 mL of LUDOX TM-50 were added. After LUDOX was added, the solutions were stirred for 10 minutes and then 2 mL of freshly prepared 50 mg/mL ammonium persulfate (APS, Sigma Aldrich) solution was added. The solutions were stirred for 24 hours during which the solutions became dark green. If stirring was stopped after 8 hours, the solution became transparent and substantial amounts of sedimentation occurred. Following 24 hours of reaction time, the precipitates were collected via centrifugation and washed with copious amounts of water and then ethanol. As needed, small amounts of the samples were dried in a 90° C. oven for characterization, but the majority of samples were kept in a small amount of ethanol. Samples prepared with PMo1 (both solution and dried product) are herein referred to as MoPL5, MoPL10, MoPL20, which correspond to samples prepared with nominal PMo1:aniline:SiO₂ ratios of 1:1:5, 1:1:10 and 1:1:20 (wt % of 38:15:47, 26:10:64 and 16:6:78), respectively.

Control samples were similarly synthesized without PMo1 by adding 0.107 mL aniline to 100 mL of 0.0124M HCl solution. This solution mimics 1:1 aniline:acid mole ratio used in experiments performed with PMo1. To this solution 0.51, 1.01 or 2.02 mL of LUDOX TM-50 was added to prepare solutions with nominal aniline:SiO₂ mole ratios of 1:5, 1:10 and 1:20, respectively. After LUDOX was added, the solutions were allowed to stir for 10 minutes and then 2 mL of fresh 50 mg/mL ammonium persulfate (Sigma Aldrich) solution was added. The solutions were stirred for 24 hours during which the solution became dark green. If stirring was stopped, the solution remained dark green and negligible sedimentation was observed. Following 24 hours of reaction time, the sample was collected via centrifugation and washed with copious amounts of ethanol. As needed, small amounts of the samples were dried in a 90° C. oven for characterization. The control samples (both solution and dried product) are herein referred to as PL5, PL10, and PL20 which correspond to samples prepared with nominal aniline:SiO₂ ratios of 1:1:5, 1:1:10 and 1:1:20, respectively.

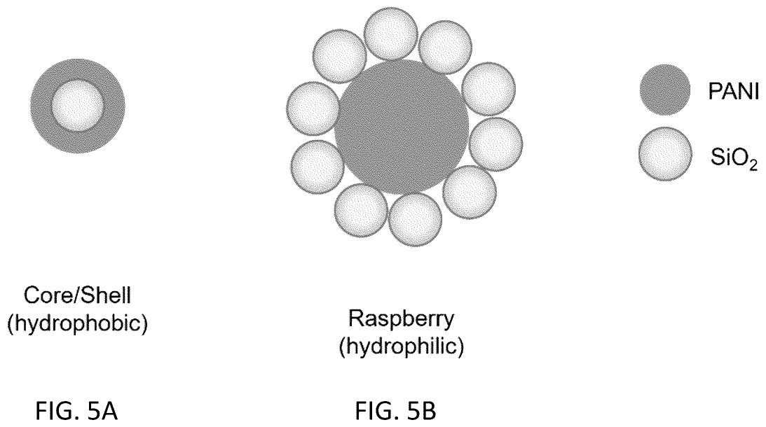

DLS and Zeta potential studies were performed to monitor the particle size and surface charge as the reaction of the MoPL nanocomposites progressed. Data was collected from the initial diluted LUDOX solution (T=−1) to 8 hours after ammonium persulfate was added (T=0 represents the solutions which contain all the precursors without ammonium persulfate). In addition, to mimic the potential dissolution of PMo1 into molybdate (MoO₄²⁻) and phosphate species, the same procedure was performed using sodium molybdate (Na₂MoO₄) and phosphoric acid. Initially, the diluted LUDOX TM-50 particle size ranges from 15-40 nm, which is consistent with manufacturer's product specifications. For MoPL samples, the mean particles size remains relatively constant during polymerization. In contrast, the PL20, PL10 and PL5 control samples have an increase in the mean particles after 4 hours to 450 nm, 380 nm and 372 nm, respectively. These increase to 480 nm, 415 nm and 693 nm after 6 hours and then to 636 nm, 620 nm and 589 nm after 8 hours. After 24 hours, the smallest observed particles decrease in size to 409 nm, 452 nm and 545 nm, but this is likely due to the aggregation and sedimentation of large particles. Large particles in PL20, PL10, PL5 are also observed in the Z-average data. The Z-average is the average particle size in a solution based on a monomodal distribution. For MoPL samples, the Z-Average, reveals the presence of much larger particles, particularly after 4 hours. This is rationalized at least in part by the severe aggregation of particles which was observed during DLS analysis. The decrease in Z-average size after 8 hours is attributed at least in part to sedimentation of large aggregates and the presence of partially or non-coated silica particles that did not aggregate. The Z-average of control samples (PL5, PL10, and PL20) show steady particle size growth. This is attributed at least in part to the PANI granule growth, and subsequent coating of their surface with SiO₂ nanoparticles, as shown in FIG. 5A. The control samples were water stable, further suggesting the formation of raspberry composites, as shown in FIG. 5B. Samples prepared with Na₂MoO₄ and H₃PO₄ showed aggregation, suggesting that PMo1 cannot be replaced with molybdate ions and phosphoric acid.

Zeta potential time-dependent studies show similar surface properties across all samples. Diluted LUDOX has a zeta potential of −35 eV, caused by the large amount of surface hydroxyl (OH) groups. Upon addition of the precursors (T=0) there is an immediate increase in the zeta potential to an average of −2.1 eV and −2.9 eV for the MoPL and PL samples, respectively. As time progresses, the zeta potential remains relatively similar with an average Zeta potential at −2.5 eV (excluding the Na₂MoO₄ and H₃PO₄) for all samples until 6 hours have passed. At this point there is an increase in the Zeta-potential of MoPL5 sample to −6.2 eV, while the Zeta-potential of MoPL10 or MoPL20 remains the same. The increase in Zeta potential is likely caused by sedimentation of heavily coated particles while uncoated or partially coated SiO₂ remain suspended in solution.

The experimental observations and time dependent DLS studies can help determine whether the MoPL products have raspberry or core/shell morphologies. Raspberry morphologies include positively charged polyaniline granules that are coated with negatively charged colloidal silica nanoparticles. These are typically dispersible in aqueous solutions due at least in part to the negative surface charge of the exposed silica. In contrast, core/shell morphologies include silica particles (core) that are individually coated with polyaniline (shell). Core/shell particles are expected to be less water stable due at least in part to the hydrophobicity of PANI, and typically have a more positive surface charge due at least in part to protonated PANI dominating the surface. The observed behavior of the PL control sample, specifically the water stability and large particle size, suggests that particles with raspberry morphologies are present. In contrast, the small particles observed by DLS in MoPL solutions, as well as the aggregation and sedimentation of particles, suggest that addition of PMo1 results in different morphology with a PANI shell or outer coating.

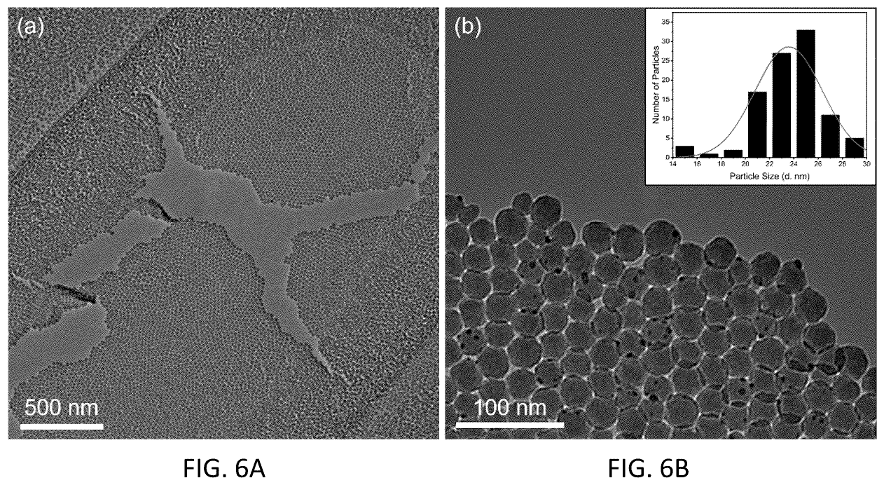

TEM analysis was conducted on MoPL10 aliquots taken after four hours of polymerization to determine if silica/PANI core-shell particles form. TEM micrographs obtained from the drop casted solution are shown in FIGS. 6A and 6B. A homogenous distribution of particles is shown in the low magnification image and indicates that the silica nanoparticles are likely coated with PANI. Without a hydrophobic coating, silica nanoparticles tend to aggregate when drop casted, while coated nanoparticles will homogenously distribute on or coat. High magnification micrograph shows spherical nanoparticles with sizes ranging from 15-30 nm in diameter. A histogram of 100 particles shows the particle distribution is consistent with DLS analysis, with most particles between 20 and 28 nm. The nanoparticles imaged have a distinct ring on their edges.

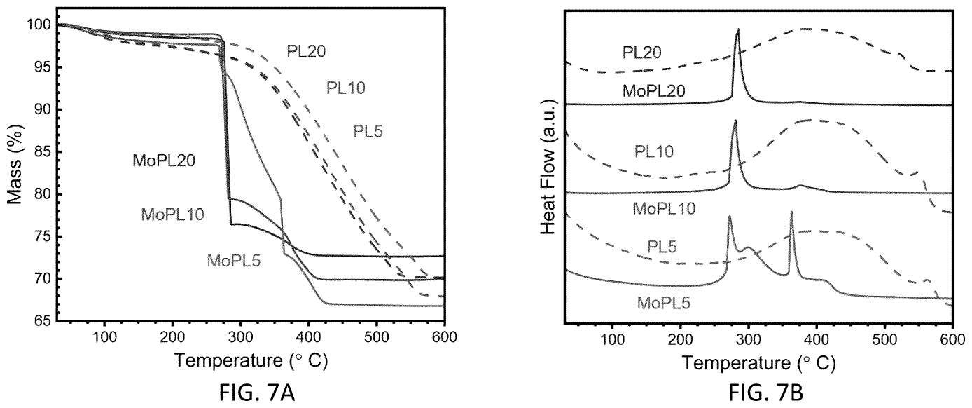

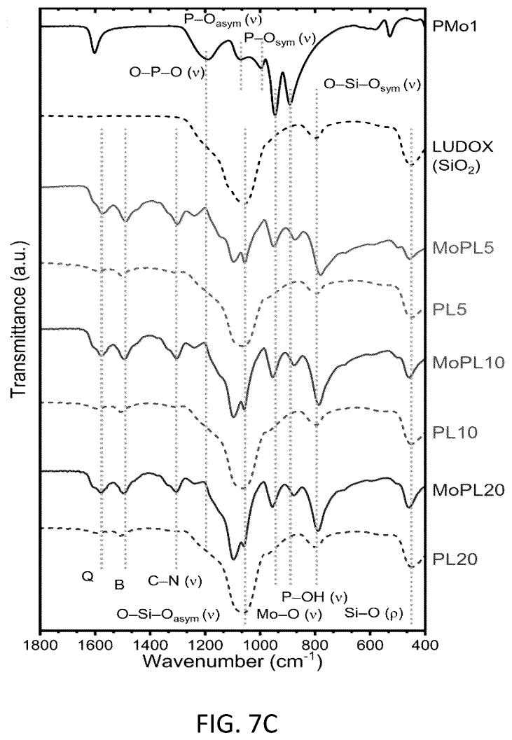

To determine the relative amount of organic species present in the samples, thermogravimetric analysis was performed. FIGS. 7A and 7B show the thermograms and simulated DSC graphs of the MoPL and PL samples, and the difference in mass loss behavior between samples is observed. Below 250° C., there is a 2-3% mass loss in all thermograms, which is likely caused by the loss of adsorbed water or ethanol. After this, the MoPL and PL samples vary dramatically. MoPL samples have an immediate and weight loss at 275° C. This accounts for mass losses of 4, 18 and 22%, respectively, for MoPL5, MoPL10 and MoPL20. Additional mass loss with a slower rate occurs between 285° C. and 360° C. in all PMo1 samples, as well as a final mass loss from 360° C. to 430° C. This final mass loss is gradual for MoPL10 and MoPL20, but the MoPL10 sample experiences an immediate loss of 8% at 360° C. followed by a more gradual mass loss. The immediate mass loss in all samples corresponds to sharp exothermic peaks in simulated DSC graphs, whereas the more gradual mass loss shows intense, but broad, exothermic events. Overall, the mass loss assigned to PANI (mass loss from 150° C.-600° C.) in MoPL5, MoPL10 and MoPL20 was 31, 29 and 26% of their mass. PL5, PL10 and PL20 control samples exhibited a slow, relatively constant, mass loss that begins at 300° C. and ends at 590° C., 570° C. and 530° C., respectively. On average, the PL control samples lost 30% of their mass. The simulated DSC graphs show broad exothermic peaks corresponding to the mass loss from the sample. Overall, the difference in thermograms and DSC data further supports different morphologies of the final products. For MoPL samples, the first dramatic mass loss can be due at least in part to a thin coating on the surface of LUDOX particles. A homogenous, thin coating could potentially combust at the same time leading to an instantaneous mass loss. The last mass loss in MoPL samples, which is most obvious in the MoPL5, could be from the combustion of PANI from raspberry-like structures. This is supported at least in part by the near identical mass loss rate of −0.13%/° C. and −0.12%/° C. between 390° C. and 410° C. for the MoPL5 and PL5 samples, respectively. Regardless, TGA analysis reveals more differences in MoPL and PL nanocomposites and further suggests that the addition of PMo1 dramatically affects the final products.

To confirm the presence of silica, PANI and phosphomolybdate species FT-IR analysis was performed and the spectra of all samples are shown in FIG. 7C. Peak positions and assignments are given in Table 6. In the PL5, PL10, and PL20 samples, six peaks are seen at 1590 cm⁻¹, 1506 cm⁻¹, 1313 cm⁻¹, 1064 cm⁻¹, 795 cm⁻¹, and 453 cm⁻¹. The peaks at 1590 cm⁻¹, 1506 cm⁻¹ and 1313 cm⁻¹ are assigned to the quinoid ring stretch, benzoid ring stretch and C—N stretch of PANI, respectively. The presence of these peaks confirms presence of PANI. Meanwhile, the peaks at 1064 cm⁻¹, 795 cm⁻¹ and 453 cm⁻¹ are assigned, respectively, to the asymmetric Si—O—Si stretch, symmetric Si—O—Si stretch and Si—O rocking mode which confirms the presence of silica. While PANI is present, the spectra of the PL control samples are dominated by the SiO₂ vibrations.

TABLE 6
Observed FT-IR peak positions (cm⁻¹) and assignments for PMo1,
LUDOX, MoPL and PL products. The symbols ν, δ and ρ
represent stretching, bending, and rocking vibrational modes, respectively.

| Assignment | PMo1 | LUDOX | PP5L | P5L | PP10L | P10L | PP20L | P20L |
|---|---|---|---|---|---|---|---|---|
| H—O—H (bend) | 1600 | — | — | — | — | — | — | — |
| Quinoid (Q) | — | — | 1602 | 1593 | 1604 | 1569 | 1610 | 1593 |
| | | | 1569 | | 1577 | | 1577 | |
| Benzoid (B) | — | — | 1488 | 1500 | 1490 | 1500 | 1496 | 1500 |
| | | | 1444 | | 1454 | | 1456 | |
| C—N | — | — | 1338 | 1319 | 1336 | 1319 | 1336 | 1307 |
| | | | 1301 | | 1303 | | 1303 | |
| O—P—O | 1189 | — | 1238 | — | 1234 | — | 1232 | — |
| Si—O—Si | — | 1056 | 1076 | 1072 | 1076 | 1066 | 1076 | 1064 |
| P—O (asym.) | 1074 | — | 1099 | — | 1097 | — | 1101 | — |
| P—O (sym.) | 991 | — | 1054 | — | 1054 | — | 1056 | — |
| Mo—O | 943 | — | 952 | — | 952 | — | 954 | — |
| P—OH | 891 | — | 873 | — | 875 | — | 879 | — |
| O—Si—O | — | 800 | 784 | 802 | 788 | 798 | 792 | 798 |
| C—H | — | — | 784 | — | 788 | — | 792 | — |
| (monosub.) | | | | | | | | |
| Si—O (rock) | — | 453 | 457 | 453 | 459 | 449 | 457 | 447 |

In contrast, the PANI vibrations are stronger in the FT-IR spectra of MoPL, which also has peaks assignable to silica, molybdenum phosphate and aniline monomers. The clearest peak assignable to phosphate species is the O—P—O vibration at 1236 cm⁻¹. Asymmetric and symmetric P—O stretches can cause the split peak, near the asymmetric Si—O—Si stretch, at 1093 cm⁻¹ and 1054 cm⁻¹, respectively. A blue shift of the O—P—O and P—O stretches exists in the MoPL spectra compared to their positions at 1189 cm⁻¹, 1074 cm⁻¹ and 1099 cm⁻¹ in the spectra of PMo1. Lastly, peaks at 962 cm⁻¹ and 875 cm⁻¹ are assigned to Mo—O and P—O—H stretches, respectively, and are consistent with the PMo1 spectra. PANI peaks are also identified in the MoPL samples through FT-IR and are stronger than in PL control samples. Peaks at 1575 cm⁻¹ 1490 cm⁻¹, and 1300 cm⁻¹, assigned to quinoid, benzoid, and C—N stretches as described above, reveal the presence of PANI but are more intense. Additional peaks suggest unpolymerized PANI is also present. This is supported at least in part by the presence of a larger peak at 788 cm⁻¹, which can be assigned to a combination of C—H from mono- and disubstituted benzene rings in addition to the symmetric Si—O—Si. Furthermore, there is a clear shoulder at 1615 cm⁻¹ which can be assigned to N—H scissoring of primary aromatic amines. The presence of aniline monomer is also supported by the presence of peaks from 3300 cm⁻¹-3000 cm⁻¹ (not shown) which can be assigned to N—H stretches from primary amines.

To assess the aggregate structures, SEM measurements were performed on samples obtained after complete polymerization (e.g., after 24 hours of reaction time), MoPL5, MoPL10, MoPL20, PL5, PL10 and PL20. The PL control samples exhibit aggregate particles about 200 nm in diameter, which are rough. The rough surface is caused by silica nanoparticles, which cover the surface of aggregated particles, and can be easily distinguished. The micrographs are consistent with raspberry-type morphologies, which are expected from the control samples. In contrast, the samples polymerized with PMo1 have a smoother appearance. Individual silica nanoparticles are not prominent on the surface of the aggregates. The smoother surface of the aggregates is attributed at least in part to PANI that has coated the surface of the aggregates. While it is difficult to determine if core/shell particles are present, core/shell nanoparticles that are aggregated together and feature an additional outer layer of PANI would result in a dense, connected polyaniline surface as observed.

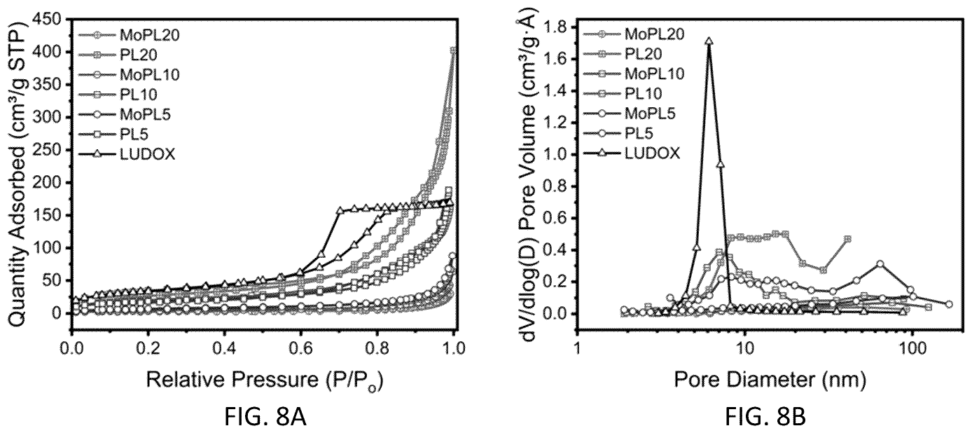

To assess the morphological differences of the polyaniline coatings, surface area analysis was performed on the samples. Table 7 shows pertinent surface area measurements. BET isotherms and BJH desorption pore distributions of MoPL and PL samples are shown in FIGS. 8A and 8B. The PL control samples had relatively high surface areas of 123, 72 and 66 m²/g, respectively, for PL5, PL10 and PL20. Hysteresis loops in the BET isotherms suggest the presence of small mesopores are present. This is confirmed by the BJH desorption pore distributions, with pores ranging from 10-15 nm in diameter for all three samples. In contrast, MoPL samples had smaller BET surface areas. For MoPL5, MoPL10 and MoPL20, the BET surface areas were measured to be 11 m²/g, 16 m²/g and 26 m²/g, respectively. Moreover, in contrast to PL samples, negligible pores are observed in BJH pore distribution and negligible hysteresis loops were present in the respective BET isotherms. This low surface area is potentially caused at least in part by a PANI coating on the surface of the aggregates, which is consistent with the dense, smooth appearance of the MoPL aggregates observed via SEM.

TABLE 7
BET surface areas, t-plot micropore and external surface
area of MoPL5, MoPL10, MoPL20, PL5, PL10 and PL20.

| | MoPL5 | PL5 | MoPL10 | PL10 | MoPL20 | PL20 | LUDOX |
|---|---|---|---|---|---|---|---|
| BET Surface Area (m²/g) | 11.84 | 123.20 | 16.75 | 72.98 | 26.02 | 66.94 | 123.06 |
| t-Plot Micropore Area (m²/g) | 5.14 | 21.60 | — | 9.71 | 1.70 | 6.13 | 10.30 |
| t-Plot External Surface Area | 6.69 | 101.60 | 16.88 | 63.27 | 24.32 | 60.81 | 112.76 |
| (m²/g) | | | | | | | |

XPS analysis was performed on MoPL10 and PL10 to determine differences in the surface composition. The atomic surface composition of PL10 was determined to be 18% C, 1% N, 45% O and 35% Si, suggesting that the surface is dominated by SiO₂ nanoparticles. The low carbon and nitrogen content is attributed to the negligible presence of PANI on the surface of raspberry-type particles. In contrast, MoPL10 has an elemental surface composition of 45% C, 16% N, 23% 0, 8% Si, 6% Mo and 1% P. The higher atomic percentage of carbon and nitrogen in the PMo1 sample suggests that the surface of the composite is indeed coated with polyaniline. The 6:1 Mo:P atomic ratio is close to the expected 5:2 ratio in the Strandberg-type polyoxometalate (Mo₅O₁₅(PO₄)(HPO₄)).

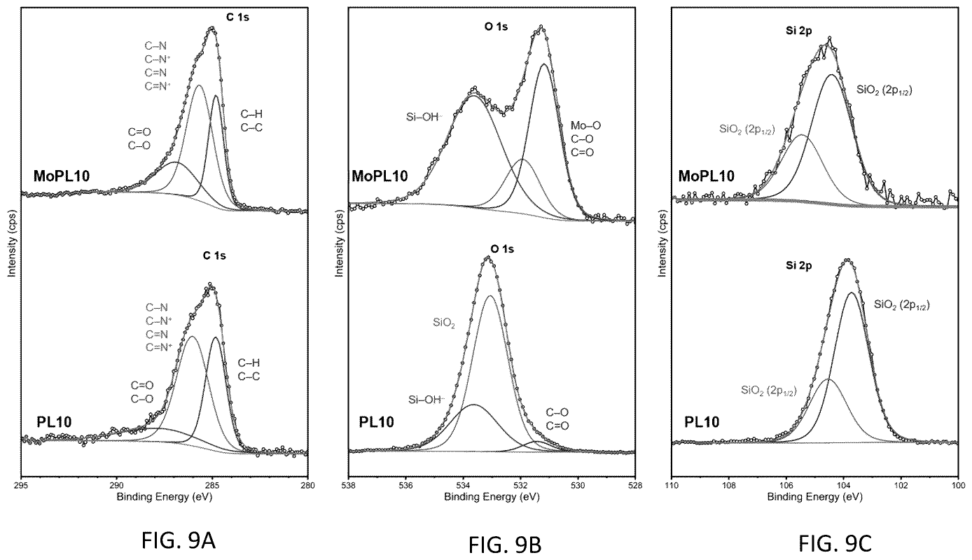

High resolution XPS spectra of the C 1s, O 1s and Si 2p regions were performed with component positions and contributions shown in Table 8 and FIGS. 9A-9C. Due at least in part to the overlap with the Mo 3p binding energies, the N Is high resolution spectra are not discussed. High-resolution C 1s spectra of MoPL10 and PL10 are shown in FIG. 9A. Each spectrum can be fitted with three components with positions of 284.8 eV, 285.7 eV and 287.7 eV for MoPL10, and positions of 284.5 eV, 285.4 eV, and 286.7 eV for PL10. The two low-binding energy components at approximately 284 eV and 285 eV of each spectrum can be assigned to adventitious/C—C/C—H species and C—N/C—N⁺/C═N/C═N⁺ chemical states from PANI, respectively. The comparison of the components C—N/C—N⁺/C═N/C═N⁺ can reveal shifts in binding energies, signifying the difference in non-conductive and conductive PANI. A slight difference in this peak is observed between MoPL10 (284.4 eV) and PL10 (285.7 eV) spectra. This suggests that MoPL samples may be slightly less conductive than the control samples. The third peak in both spectra can be attributed to C═O/C—O species, with the primary candidates being benzoquinone and hydroxyquinone which are known by products of aniline polymerized through chemical oxidation.

TABLE 8
Binding energies (eV) of deconvoluted components for MoPL10 and
PL10 (component contributions are indicated in parentheses).

| Assignment | MoPL10 | PL10 |
|---|---|---|
| | 286.7 | 287.82 |
| | (22) | (15) |
| C 1s | 285.4 | 286.03 |
| | (50) | (51) |
| | 284.5 | 284.8 |
| | (28) | (33) |
| O 1s | 533.61 | 533.63 |
| | (48) | (28) |
| | 531.92 | 533.06 |
| | (16) | (68) |
| | 531.17 | 531.44 |
| | (36) | (4) |
| Si 2p | 105.45 | 104.54 |
| | (34) | (32) |
| | 104.41 | 103.73 |
| | (66) | (68) |
| Mo 3d_{3/2} | 234.03 | — |
| | (20) | |
| | 233.52 | — |
| | (80) | |

While the C 1s regions were similar, the O 1s high resolution spectra of MoPL10 and PL10 are different, as shown in FIG. 9B. PL10 has one large signal which can be fitted with three components with positions of 531.4 eV, 533.0 eV and 533.6 eV with contributions of 4%, 68% and 28%, respectively. These are assigned to organic contaminants (or benzoquinone and hydroxyquinone), SiO₂ and surface Si—O— or Si—OH-chemical states. The O 1s spectra of MoPL10 is different but can also be fitted with three components with positions of 531.0 eV, 531.8 eV and 533.3 eV with contributions of 41%, 6% and 53%, respectively. The first component is assigned to Mo—O and the last component is assigned to Si—O or Si—OH. The component at 531.8 eV may be SiO₂ or a carbon species.

The Si 2p high resolution spectra are shown in FIG. 9C. The PL10 has two components located at 103.7 and 104.5 eV which can be assigned to Si 2p_{3/2} and 2p_{1/2} of SiO₂. This agrees with XPS analysis of other silica species, although the splitting energy is slightly larger than the expected 0.6 eV. For the MoPL10, two components were also identified. Their locations, however, have shifted to higher binding energies, and are located at 104.4 and 105.4 eV. These are also assigned to Si 2p_{3/2} and Si 2p_{1/2}. The incorporation of phosphomolybdate species may affect Si 2p due at least in part to interactions between the coating and LUDOX particles.

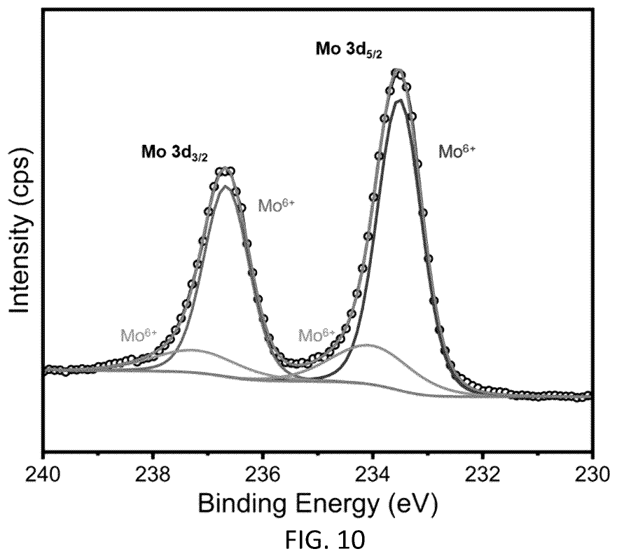

The Mo 3d high-resolution spectra of MoPL10 was also analyzed to determine the oxidation state of molybdenum, as shown in FIG. 10. The Mo 3d peak exhibits spin splitting and thus 3d_{5/2} and 3d_{3/2} deconvoluted components are observed at 233.2 eV and 236.4 eV. In addition to the main 3d_{5/2} and 3d_{3/2} Mo⁶⁺ components, another Mo chemical state with 3d_{5/2} and 3d_{3/2} splitting is present with binding energies of 233.8 eV and 236.9 eV. XPS analysis suggests that the composite prepared with PMo1 contains silica particles that are individually coated with PANI that is impregnated with a molybdenum phosphate species.

To synthesize PMo1-PANI-cellulose nanocrystals (CNC) nanocomposites, 0.300 g (1.24 mmole) of PMo1 was dissolved in 100 mL deionized water on a 60° C. hotplate. When PMo1 was fully dissolved, the solution was cooled and 0.107 mL (1.24 mmole) of aniline (Sigma Aldrich) was added to prepare a PMo1-PANI solution. To this, a CNC suspension in water (DextraCel HP, Anomera) was added. To prepare the solutions with the aniline:CNC weight ratios of 1:6, 1:10 and 1:12, 0.648 g, 1.091 g, and 1.308 g of CNC suspensions were added to each of three of the PMo1-PANI solutions, respectively. After the CNC was added, the solutions were stirred for 10 minutes and then 2 mL of freshly prepared 50 mg/mL ammonium persulfate (APS, Sigma Aldrich) solution was added. The solutions were stirred for 24 hours during which the solutions became dark green. Following 24 hours of reaction time, the precipitates were collected via centrifugation and washed with copious amounts of water and then ethanol. As needed, small amounts of the samples were dried in a 90° C. oven for characterization, but the majority of samples were kept in a small amount of ethanol. Samples prepared with PMo1 (both solution and dried product) are herein referred to as MoPC6, MoPC10, MoPC12 which correspond to samples prepared with aniline:CNC ratios of 1:1:6, 1:1:10 and 1:1:12 (dry wt % of 37:13:50, 27:9:64 and 23:8:69), respectively.

Control samples were similarly synthesized without PMo1 by adding 0.107 mL aniline to 100 mL of 11.7 mM H₃PO₄ solution. This solution mimics 1:1 aniline:acid mole ratio used with PMo1. To this solution, 0.648 g of CNC of DextraCel cellulose was added to prepare solution with nominal aniline:CNC weight ratios of 1:6. After CNC suspension was added, the solutions were allowed to stir for 10 minutes and then 2 mL of fresh 50 mg/mL ammonium persulfate (Sigma Aldrich) solution was added. The solutions were stirred for 24 hours during which the solution became dark green. Following 24 hours of reaction time, the sample was collected via centrifugation and washed with copious amounts of ethanol. As needed, small amounts of the samples were dried in a 90° C. oven for characterization. The control samples (both solution and dried product) are herein referred to as PC6 which correspond to samples prepared with nominal aniline:CNC ratios of 1:6. This contrasts with measurements performed with PMo1.

When PMo1 is used, a thicker coating on the beaker walls and little of the PANI precipitate in the supernatant was observed. In contrast, the control assessments produced a considerable amount of precipitate suspended in solution and visually thinner films on the beaker walls.

To assess PMo1-PANI-CNC nanocomposites, SEM was performed using a Zeiss Auriga FIB/SEM operated at 5 kV. The coated silicon wafers were mounted on aluminum SEM stubs using conductive carbon tape and subsequently gold-coated to enhance surface conductivity prior to imaging. PXRD analysis was performed using a Malvern PANalytical Aeris X-ray Diffractometer equipped with a Cu Kα radiation source (λ=1.5406 Å). The diffraction patterns were recorded over a 2θ range of 10°-65° fourier transform infrared (FT-IR) spectra were recorded using a Bruker IFS66 V/S attenuated total reflection ATR FT-IR spectrometer.

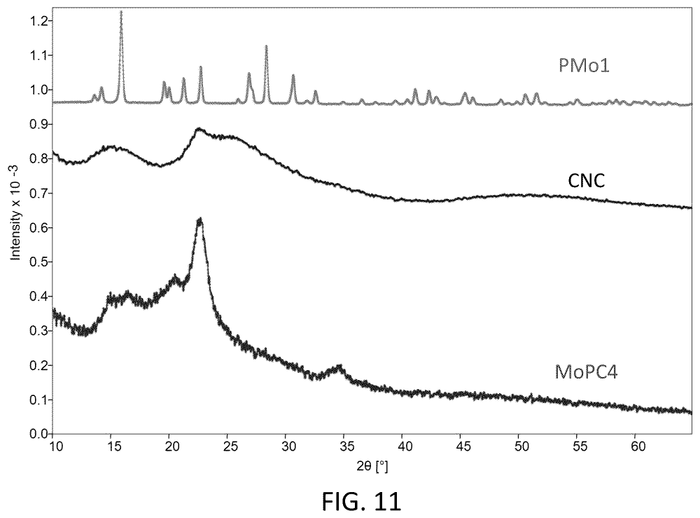

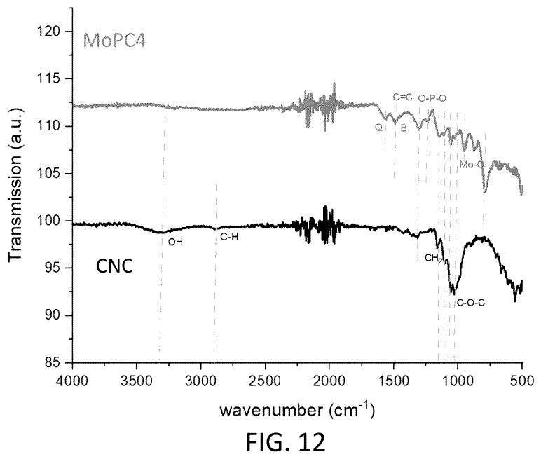

SEM micrographs of the bare CNC reveal a uniformly distributed fibrous morphology composed of rod-like nanocellulose bundles forming an interlaced network across the substrate surface. The CNC appear as slender fibrils with smooth surfaces and aggregation, consistent with the typical nanoscale texture of cellulose nanocrystals. The fibrous arrangement provides an extended high-surface-area framework suitable for subsequent polymer deposition. SEM images of the PMo1-PANI-CNC nanocomposite films display a similar but more densely packed fibrous network, indicating that the CNC scaffold was preserved during polymerization while becoming coated with polyaniline. The surface morphology appears continuous, with entangled fibrils and interconnected web-like structures covering the silicon wafer substrate. At a higher magnification, the PMo1-PANI-CNC nanocomposites exhibit roughened fiber surfaces and localized aggregated domains, suggesting conformal polymer deposition along the CNC framework and partial fusion between adjacent coated fibrils. The resulting composite film shows a hierarchically textured surface. Comparison of the SEM micrographs of the bare CNC and PMo1-PANI-CNC nanocomposite confirms that the fibrous cellulose template guides the final composite morphology. The preservation of the CNC network after PANI incorporation demonstrates that polymer growth occurs preferentially along the CNC surfaces, forming an interconnected conductive network without disrupting the underlying nanocellulose scaffold. The PXRD patterns in FIG. 11 and the FT-IR spectra in FIG. 12 confirm the differences between the CNC and PMo1-PANI-CNC nanocomposite.

TABLE 9
Peak assignments for CNC and the MoPC4 samples.
MoPC4 corresponds to samples prepared with
nominal PMo1:aniline:CNC ratios of 1:1:4.

| | Characteristic |
|---|---|
| Assignment | band (cm⁻¹) |
| O—H stretching (cellulose, adsorbed water) | 3400 |
| C═C (quinoid ring) | 1560 |
| C═C (benzenoid ring) | 1480 |
| C—N stretching | 1290 |
| P—O asymmetric stretching | 1107 |
| P—O symmetric stretching | 1053 |
| Mo—O stretching | 941 |
| P—OH or O—H deformation | 870 |
| C—O—C and C—O stretching (cellulose) | 1050-1000 |

Dispersion stability of the CNC and PMo1-PANI-CNC nanocomposite formulations was evaluated by dispersing the samples in various solvents of differing polarity, including water, methanol, ethanol, isopropyl alcohol, and acetone. Approximately equal quantities of each sample were added to the respective solvents and sonicated to ensure uniform dispersion. Stability of these dispersions was monitored over the span of 3 days. Dispersion stability of the CNC and PMo1-PANI-CNC nanocomposite samples was evaluated by dispersing each material in solvents of varying polarity, including water, methanol, ethanol, isopropyl alcohol, and acetone. The samples were sonicated to ensure uniform dispersion, and their stability was monitored over a period of three days. Pure CNC remained well-dispersed only in water, while the PMo1-PANI-CNC nanocomposite prepared using PMo1 exhibited enhanced stability in polar solvents due at least in part to interfacial polymerization and electrostatic stabilization by the polyoxometalate. The H₃PO₄-based PANI-CNC nanocomposite (PC6) showed reduced dispersion stability, with visible aggregation and sedimentation in less polar solvents.

To assess the reactions in the absence of ammonium persulfate, a series of reactions was performed using PMo1 solutions of varying molarities, 0.40, 0.15, 0.10, 0.08, and 0.02 M. The solutions were prepared by first adding appropriate amounts of PMo1 in a fixed solvent volume of 15 mL and by subsequently heating the mixtures in a 60° C. oven and then cooling to room temperature. The solutions showed an intense yellow to light yellow color to colorless to the naked eyes, as the concentration decreased. Separately, aniline (Sigma Aldrich, 99.5%) was dissolved in deionized water and mixed into the PMo1 solutions such that the molar ratio of PMo1 and aniline was 1:2. Appropriate amounts of deionized water were mixed in the solutions to give the final molarities of PMo1 and aniline of 0.10 M (PMAa), 0.06 M (PMAb), 0.05 M (PMAc), 0.04 M (PMAd), and 0.01 M (PMAe). Upon mixing the aniline solution to the PMo1 solutions, it was observed that bluish green precipitates began to form within five minutes along with pale yellow needle-like crystals, for the PMAa-c solutions. For PMAd, the pale-yellow needle-like crystals appeared without the formation of any colored solid products. The PMAe solution remained transparent throughout the process and did not yield any solid product. The solutions were kept undisturbed for two hours. The needle-like crystals from the PMAd solution were collected by vacuum filtration and subsequent washing with 150 mL of hexane. The needle-like crystals were readily soluble in water. The colored solid products from PMAa-c solutions were collected by vacuum filtration, washed repeatedly with water, and dried at room temperature. The repeated water washing removed the needle-like crystals, leaving a blue-green solid. The products were collected and stored separately in borosilicate glass vials for further characterization. Even in the absence of ammonium persulfate, bluish-green products can be formed in air when the concentrations of PMo1 and aniline are sufficiently high.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An electrically conductive coating comprising:
polyaniline; and
metal oxide.

2. The electrically conductive coating of claim 1, wherein the metal oxide comprises a polyoxometalate.

3. The electrically conductive coating of claim 1, wherein the metal oxide comprises a Strandberg-type metal oxide cluster.

4. The electrically conductive coating of claim 3, wherein the Strandberg-type metal oxide cluster comprises a [Mo₅O₁₅(PO₄)₂]⁶⁻ metal oxide cluster.

5. The electrically conductive coating of claim 1, wherein the metal oxide comprises a transition metal having a formal oxidation state of 4+, 5+, or 6+.

6. The electrically conductive coating of claim 1, wherein a thickness of the coating is in a range of 1 nm to 10 μm.

7. The electrically conductive coating of claim 1, wherein the coating is continuous with no visual voids greater than 10 nm.

8. The electrically conductive coating of claim 1, wherein the polyaniline, the metal oxide, or both are in the form of nanoparticles.

9. The electrically conductive coating of claim 8, wherein an average diameter of the nanoparticles is 100 nm or less.

10. A coated substrate comprising:
a substrate; and
the electrically conductive coating of claim 1 on the substrate.

11. The coated substrate of claim 10, wherein the substrate comprises paper, a polymer, or an inorganic compound.

12. An aqueous composition comprising:
aniline; and
metal oxide clusters.

13. The aqueous composition of claim 12, wherein the metal oxide clusters comprise Strandberg-type [Mo₅O₁₅(PO₄)₂]⁶⁻ metal oxide clusters.

14. A coating formed from the composition of claim 12.

15. A method of depositing an electrically conductive coating on a substrate, the method comprising:
dissolving a metal oxide in a solvent to yield a solution;
combining aniline with the solution to yield a first mixture comprising polyoxometalate;
combining an oxidizing agent with the first mixture to yield a second mixture;
contacting a substrate with the second mixture to yield a coated substrate;
removing the coated substrate from the second mixture; and
drying the coated substrate.

16. The method of claim 15, wherein dissolving the metal oxide in the solvent comprises combining the metal oxide to yield a mixture, and heating the mixture to yield the solution.

17. The method of claim 15, further comprising, before contacting the substrate with the second mixture, heating the second mixture to a temperature no greater than 100° C.

18. The method of claim 15, wherein the substrate comprises an electrically insulating material.

19. The method of claim 18, wherein the electrically insulating material comprises an organic material, a polymer, or an inorganic material.

20. The method of claim 15, wherein a molar ratio of the aniline to a metal in the metal oxide is in a range of about 1:1 to about 3:1.

21. The method of claim 15, wherein the metal oxide comprises MoO₂(HPO₄)(H₂O).
